(19) United States
(12) Patent Application Publication
(10) Pub. No.: US 2007/0299160 A1
(43) Pub. Date: Dec. 27, 2007

(54) Insulating Extrudates from Polyolefin Blends

(76) Inventors: Jean-Luc Delanaye, Kraainem (BE); Martine Marchand, Charmes-Sur-Rhone (FR)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/659,270

(22) PCT Filed: Sep. 21, 2004
(86) PCT No.: PCT/US04/30853

§ 371 Date: Jun. 19, 2007

(51) Int. Cl. C08J 9/32

(52) U.S. Cl. 523/218

(57) ABSTRACT

Hollow microspherical, mineral or hard plastic, fillers are used to increase the insulation properties of thermoplastic olefin compositions, especially where used in extruded profiles, sheets or tapes. The thermoplastic olefins comprise a thermoplastic phase and a rubber phase wherein the rubber is at least partially cross-linked by dynamic vulcanization. The microspherical fillers can be added by melt blending with the pre-formed thermoplastic olefins. The natural wear-resistance, oxidative stability and thermal insulating properties of thermoplastic olefins, with the enhancement from the hollow microspheres make them particularly suitable for marine conduits, such as those used in the off-shore drilling industry in flexible pipelines, electrical cables and tethering lines.

### FIELD OF INVENTION

The invention relates to microsphere-containing polymer composites suitable for extruded profiles, sheets or tapes for use in industrial articles where flexibility, dimensional and environmental stability, and thermal insulating properties are desired.

### BACKGROUND OF INVENTION

Hollow glass beads have long been proposed for insulation composites with various resins, see U.S. Pat. No. 4,303,732, U.S. Pat. No. 4,556,603 and U.S. Pat. No. 5,713,974. Polypropylene and polyethylene have been proposed for modification with hollow, glass beads for protective, insulating covers of marine pipelines, see U.S. Pat. No. 5,094,111. Similar composites have been proposed with polypropylene copolymers and blends of those with either of elastomeric styrene-based block copolymers or EPDM rubber in U.S. Pat. No. 5,158,727, the glass beads to comprise from 5 to 70 percent by volume of the composite material. A background discussion of the development of syntactic foam thermal insulation, composite materials made from hollow glass microspheres embedded in a polymeric binder, for use in marine applications in the offshore industry appears in the article, “Syntactic Foam Thermal Insulation for Ultra-Deepwater Oil and Gas Pipelines”, L. Watkins and E. Hershey, Offshore Technology Conference (2001). And, polymeric materials comprising an olefin polymer blended with a thermoset elastomer have previously been proposed as capable of providing a suitable outer sheath for flexible pipe for improved low temperature flexibility, thermal insulation, and resistance to degradation in U.S. Pat. No. 6,701,969.

Thermoplastic vulcanizates (TPVs) are a known class of thermoplastic elastomer and may be characterized by a crosslinked rubber phase dispersed within a plastic matrix. The crosslinked rubber phase promotes elasticity but due to the discrete, particulate nature of that crosslinked rubber, does not interfere with plasticity. As such, TPVs exhibit the processing properties of the plastic and the elasticity of the rubber. Further, the TPVs in final form may be removed from other materials to which attached, and then may be melted and molded again without significant loss of mechanical properties making them exceptionally suitable for recycling.

TPVs are conventionally produced by dynamic vulcanization. Dynamic vulcanization is a process whereby a rubber component is crosslinked or vulcanized under intensive shear and mixing conditions within a blend of at least one non-vulcanizing thermoplastic polymer component while at or above the melting point of that thermoplastic. See, for example U.S. Pat. Nos. 4,594,390 and 6,147,160.

Though both thermoplastic elastomers and syntactic foams using microspheres are widely recognized, there is a prejudice in the art against using TPVs as the thermoplastic elastomers in such a manner. Intensive shearing and mixing is necessary for the rubber vulcanization, thus precluding inclusion of the beads in the elastomeric phase in view of likely breakage. Additionally, the thermoplastic phase alone in the TPVs, normally comprising a lesser volume content than the rubber phase, would not be expected to be capable of incorporating sufficient microspheres to meet the requirements for the thermal insulation properties sought.

### SUMMARY OF INVENTION

The invention comprises an insulating polymeric extrudate comprising a thermoplastic resin matrix phase having a dispersed phase of at least partially crosslinked rubber; and, hollow microspheres dispersed within the resin matrix phase. The insulating extrudates according to the invention can be prepared by melt blending microspherical, hollow inorganic or extremely hard polymeric fillers with a preformed thermoplastic vulcanizate of the thermoplastic and crosslinked rubber. The thermoplastic can be any engineering resin or blend thereof, polyolefin thermoplastics are preferred. The rubber can be any rubber capable of being dynamically crosslinked, or vulcanized, with ethylene copolymer, particularly EPDM, rubbers being preferred. They can further comprise various amounts of curatives, plasticizers, fillers, etc. The insulating filler is desirably present in amounts of from about 10 to about 45 weight percent of the thermoplastic vulcanizate total composition weight. Functionalization of the thermoplastic phase with functionalization agents and of the surface of the microspheres to enhance the bonding between the two is encompassed as well.

### DETAILED DESCRIPTION OF THE INVENTION

The microspherical particulate fillers used to modify thermoplastic vulcanizates in this invention are hollow glass, ceramic, carbon, or hard engineering resin microspheres which typically have diameters of about 15 to 350×10⁻⁶ m (15 to 350 microns) in diameter, preferably 50 to 150×10⁻⁶ m. (50 to 150 microns) Methods to produce hollow microspheres potentially suitable for insulation materials have been known in the art as disclosed in U.S. Pat. Nos. 3,030,215; 3,161,463; 3,365,315; 3,888,957; 4,303,732, 4,012,290; 4,349,456, and 5,501,871, among many. Hollow glass microspheres are commercially available, for example from Sovitec Cataphote S.A., France, and 3M Specialty Materials, U.S.A. Such are available as unmodified glass beads and as functionalised beads. Whether acquired as pre-treated, or subsequently treated, the glass microspheres can be functionalized for improved binding to functionalised thermoplastic resins, for example, those that have been amino-treated for coupling with carboxylated moieties on polyolefinic polymeric additives, see below.

The microspherical particulate fillers may be present in amounts from about 10 to about 45 weight percent of the thermoplastic vulcanizate total composition weight. Since the thermoplastic phase of the thermoplastic vulcanizate can be from about 15 to about 75 percent of the blend of the thermoplastic and rubber phase (without fillers, oils, etc.), the percentage of microspherical particulate fillers based upon the total weight of the thermoplastic vulcanizate can range from 10 or 15 to about 25 or 35 weight percent based upon the weight of the thermoplastic vulcanizate composite composition, preferably 15-25 weight percent.

The thermoplastic resin used in the invention in the thermoplastic polyolefins of the invention is a solid plastic material. Preferably, the resin is a crystalline or a semi-crystalline polymer resin, and more preferably is a resin that has a crystallinity of at least 10 percent as measured by differential scanning calorimetry. Polymers with a high glass transition temperature, e.g., non-crystalline engineering plastics, are also acceptable as the thermoplastic resin. The melt temperature of these resins should generally be lower than the decomposition temperature of the rubber. Reference to a thermoplastic resin includes a mixture of two or more different thermoplastic resins.

The thermoplastic resins preferably have a weight average molecular weight from about 50,000 to about 600,000, and a number average molecular weight from about 50,000 to about 200,000. More preferably, these resins have a weight average molecular weight from about 150,000 to about 500,000, and a number average molecular weight from about 65,000 to about 150,000.

The thermoplastic resins generally have a melt temperature (Tm) that is from about 40 to about 175° C. preferably from about 50 to about 170° C. and even more preferably from about 90 to about 170° C. The glass transition temperature (Tg) of these resins is from about −25 to about 10° C. preferably from about −5 to about 5° C.

The thermoplastic resins generally have a melt flow rate that is 0.3 dg/min—1500 dg/min, preferably 0.7 dg/min to 100 dg/min, most preferably 0.7 dg/min to 10 dg/min. Melt flow rate is a measure of how easily a polymer flows under standard pressure, and is measured by using ASTM D-1238 at 230° C. and 2.16 kg load.

Exemplary thermoplastic resins include crystallizable polyolefins. The preferred thermoplastic resins are crystallizable polyolefins that are formed by polymerizing alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. For example, known polyethylene homo- and copolymers having ethylene crystallinity are suitable. Isotactic or syndiotactic polypropylene and crystallizable copolymers of propylene and ethylene or other C₄-C₁₀ alpha-olefins, or diolefins, having isotactic or syndiotactic propylene crystallinity are typically preferred. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof are also suitable. These will include reactor polypropylene copolymers and impact polypropylene copolymers, whether block, random or of mixed polymer synthesis. These homopolymers and copolymers may be synthesized by using any polymerization technique known in the art such as, but not limited to, the “Phillips catalyzed reactions,” conventional Ziegler-Natta type polymerizations, and organometallic single-site olefin polymerization catalysis exemplified by, but not limited to, metallocene-alumoxane and metallocene-ionic activator catalysis.

Such resins are referred to herein as high modulus or highly crystalline thermoplastic polymers. An especially preferred commercially available thermoplastic resin is high-crystallinity isotactic or syndiotactic polypropylene. This polypropylene generally has a density of from about 0.85 to about 0.91 g/cm³, with the largely isotactic polypropylene having a density of from about 0.90 to about 0.91 g/cm³. Also, high and ultra-high molecular weight polypropylene that has a fractional melt flow rate is highly preferred. These polypropylene resins are characterized by a melt flow rate that is less than or equal to 10 dg/min and more preferably less that or equal to 1.0 dg/min per ASTM D-1238.

The thermoplastic resin is desirably from about 15 to about 80 parts by weight, more desirably from about 25 to about 75 parts by weight, and preferably from about 35 to about 70 parts by weight per 100 parts of the blend of thermoplastic resin and the unsaturated rubber. The rubber is desirably from about 20 to about 85 parts by weight, more desirably from about 25 to about 75 parts by weight and preferably from about 30 to about 65 parts by weight per 100 parts by weight of said blend. If the amount of thermoplastic resin is based on the amount of rubber, it is desirably from about 17.5 to about 320 parts by weight, more desirably from about 33 to about 300 parts and preferably from about 53 to about 230 parts by weight per 100 parts by weight of the rubber.

The terms “blend” and “thermoplastic vulcanizate” used herein mean a mixture ranging from small particles of crosslinked rubber well dispersed in a thermoplastic resin matrix to co-continuous phases of the thermoplastic resin and a partially to fully crosslinked rubber or combinations thereof. The term “thermoplastic vulcanizate” indicates the rubber phase is at least partially vulcanized (crosslinked).

“Thermoplastic vulcanizate” compositions possess the properties of a thermoset elastomer and but remain reprocessable in an internal mixer. Upon reaching temperatures above the softening point or melting point of the thermoplastic resin phase, they can form continuous sheets and/or molded articles with what visually appears to accomplish complete knitting or fusion of the thermoplastic vulcanizate under conventional molding or shaping conditions for thermoplastics.

Subsequent to dynamic vulcanization (curing) of the rubber phase of the thermoplastic vulcanizate, desirably less than 5 weight percent of the rubber is extractable from the specimen of the thermoplastic vulcanizate in boiling xylene. Techniques for determining extractable rubber as set forth in U.S. Pat. No. 4,311,628, are herein incorporated by reference.

The rubber can be any rubber that can react and be crosslinked under crosslinking conditions. These rubbers can include natural rubber, EPM and EPDM rubber, butyl rubber, halobutyl rubber, halogenated (e.g. brominated) copolymers of p-alkylstyrene and an isomonoolefin, homo or copolymers from at least one conjugated diene, or combinations thereof. EPDM, butyl and halobutyl rubbers are referred to as rubbers low in residual unsaturation and are preferred when the vulcanizate needs good thermal stability or oxidative stability. The rubbers low in residual unsaturation desirably have less than 10 weight percent repeat units having unsaturation. For the purpose of this invention, copolymers will be used to define polymers from two or more monomers, and polymers can have repeat units from one or more different monomers.

An easily cross-linkable rubber is preferred if at least partial cross-linking is selected. The cross-linkable rubber is desirably an olefin rubber such as EPDM-type rubber. EPDM-type rubbers are generally terpolymers derived from the polymerization of at least two different monoolefin monomers having from 2 to 10 carbon atoms, preferably 2 to 4 carbon atoms, and at least one polyunsaturated olefin having from 5 to 20 carbon atoms. Said monoolefins desirably have contain 1-12 carbon atoms and are preferably ethylene and propylene, but ethylene with 1-butene, 1-hexene, or 1-octene, are also readily suitable. Desirably the repeat units from at least two monoolefins are present in the polymer in weight ratios of 25:75 to 75:25 (ethylene:propylene) and constitute from about 90 to about 99.6 weight percent of the polymer. The polyunsaturated olefin can be a straight chained, branched, cyclic, bridged ring, bicyclic, fused ring bicyclic compound, etc., and preferably is a nonconjugated diene. Desirably repeat units from the nonconjugated polyunsaturated olefin is from about 0.4 to about 10 weight percent of the rubber. Preferred nonconjugated diolefins have 5 to 20 carbon atoms, preferably one or more selected from 1,4-hexadiene, ethylidene norbornene, vinyl norbornene, dicyclopentadiene, and the like.

The rubber can be a butyl rubber, halobutyl rubber, or a halogenated (e.g. brominated) copolymer of p-alkylstyrene and an isomonoolefin of 4 to 7 carbon atoms. “Butyl rubber” is defined a polymer predominantly comprised of repeat units from isobutylene but including a few repeat units of a monomer which provides sites for crosslinking. The monomers which provide sites for crosslinking can be a polyunsaturated monomer such as a conjugated diene or divinyl benzene. Desirably from about 90 to about 99.5 weight percent of the butyl rubber are repeat units derived from the polymerization of iso-butylene, and from about 0.5 to about 10 weight percent of the repeat units are from at least one polyunsaturated monomer having from 4 to 12 carbon atoms. Preferably the polyunsaturated monomer is isoprene or divinylbenzene. The polymer may be halogenated to further enhance reactivity in crosslinking. Preferably the halogen is present in amounts from about 0.1 to about 10 weight percent, more preferably about 0.5 to about 3.0 weight percent based upon the weight of the halogenated polymer; preferably the halogen is chlorine or bromine. Suitable rubbers include a brominated copolymer of p-alkylstyrene, having from about 9 to 12 carbon atoms, and an isomonoolefin, having from 4 to 7 carbon atoms, desirably such will have from about 88 to about 99 weight percent isomonoolefin, more desirably from about 92 to about 98 weight percent, and from about 1 to about 12 weight percent p-alkylstyrene, more desirably from about 2 to about 8 weight percent based upon the weight of the copolymer before halogenation. Desirably the alkylstyrene is p-methylstyrene and the isomonoolefin is isobutylene. Desirably the percent bromine is from about 2 to about 8, more desirably from about 3 to about 8, and preferably from about 5 to about 7.5 weight percent based on the weight of the halogenated copolymer. The halogenated copolymer is a complementary amount, i.e., from about 92 to about 98, more desirably from about 92 to about 97, and preferably from about 92.5 to about 95 weight percent. These polymers are commercially available from ExxonMobil Chemical Co.

The thermoplastic vulcanizates of this disclosure are generally prepared by the well-known method of melt-mixing the thermoplastic resin (e.g. polypropylene), the rubber, and other ingredients (filler, plasticizer, lubricant, stabilizer, etc.) in a mixer heated to above the melting temperature of the thermoplastic resin. The optional fillers (other than the hollow microspheres), plasticizers, additives etc., can be added at this stage or later. After sufficient molten-state mixing to form a well mixed blend, vulcanizing agents (also known as curatives or crosslinkers) are generally added. In some embodiments it is preferred to add the vulcanizing agent in solution with a liquid, for example rubber processing oil, or in a masterbatch which is compatible with the other components. It is convenient to follow the progress of vulcanization by monitoring mixing torque or mixing energy requirements during mixing. The mixing torque or mixing energy curve will generally go through a maximum after which mixing can be continued somewhat longer to improve the fabricability of the blend. If desired, one can add some of the ingredients after the dynamic vulcanization is completed. After discharge from the mixer, the blend containing vulcanized rubber and the thermoplastic can be milled, chopped, extruded, pelletized, injection-molded, or processed by any other desirable technique. It is usually desirable to disperse the fillers and a portion of any plasticizer to in the rubber or thermoplastic resin phase before the rubber phase or phases are crosslinked. Crosslinking (vulcanization) of the rubber can occur in a few minutes or less depending on the mix temperature, shear rate, and activators present for the curative. Suitable curing temperatures include from about 120° C. or 150° C. for a semi-crystalline polypropylene phase to about 250° C., more preferred temperatures are from about 150° C. or 170° C. to about 225° C. or 250° C. The mixing equipment can include Banburyl® mixers, Brabender® mixers, and certain mixing extruders.

The thermoplastic vulcanizate can include a variety of additives in addition to the hollow microspheres. The additives include particulate fillers such as carbon black, silica, titanium dioxide, colored pigments, clay, zinc oxide, stearic acid, stabilizers, anti-degradants, flame retardants, processing aids, adhesives, tackifiers, plasticizers, wax, discontinuous fibers (such as wood cellulose fibers) and extender oils. When extender oil is used it can be present in amounts from about 5 to about 300 parts by weight per 100 parts by weight of the blend of semi-crystalline polypropylene and rubber. The amount of extender oil (e.g., hydrocarbon oils and ester plasticizers) may also be expressed as from about 30 to 250 parts, and more desirably from about 70 to 200 parts by weight per 100 parts by weight of said rubber. When non-black fillers are used, it is desirable to include a coupling agent to compatibilize the interface between the non-black fillers and polymers. Desirable amounts of carbon black, when present, are from about 5 to about 250 parts by weight per 100 parts by weight of rubber.

In addition, polymeric additives can be used to modify the overall properties of the invention TPV compositions. Known polymeric additives include thermoplastics such as un-crosslinked ethylene-propylene rubber, very low density polyethylene copolymers, styrene block copolymers, particularly, styrene-ethylene-butene-styrene (SEBS) thermoplastics, and semi-crystalline propylene homopolymers or random copolymers having from about 1-20 wt. % of ethylene or α-olefins containing 4-8 carbon atoms. Such modifiers may also be functionalized with from about 0.2 to about 5 wt. % polar moieties, such as carboxy-acids/anhydrides, amino-, epoxy- and similar moieties. Preferred additive for increased bonding of the TPV to glass beads, particularly, sized, or treated, glass beads are functionalised polyolefin thermoplastics such as semi-crystalline polypropylene homo- or copolymer that has been grafted with maleic anhydride, and maleated SEBS. Commercial polymers useful for such include ExxonMobil Chemical Company products Exxelor® PO 1015 (polypropylene functionalized with 0.25 to 0.5 wt. % maleic anhydride) and Exxelor® VA 1840 (ethylene copolymer functionalized with 0.25 to 0.5 wt. % maleic anhydride), and Kraton Polymers product KRATON® FG1901X (styrene-ethylene-butene-styrene copolymer functionalized with 1.7 to 2.0 wt. % maleic anhydride). Such polymeric additives may present in an amount up to 20 wt. % of the total polymeric content, and will typically be used in a range of 10-20 wt. % when present.

The syntactic foams in accordance with the invention can be prepared by selecting the base TPV product in accordance with the above description and melt mixing with the described microspheres. The resulting product can be finished as sheets, bales or pellets, in accordance with standard methods for finishing thermoplastic products. Care should be given however, to using low intensity shear forces in such preparation and finishing so as to avoid breakage of a significant number the microspheres, e.g., less than 10%. Thus in the preparation of the syntactic foams, the TPV product is heated to above its melting temperature, typically, 170 to 230° C., and mixed with the microspheres while in a molten state, typically in an internal mixer such as a Banbury, Buss extruder, or single or twin screw extruder, where the mixing speed and blade/stirrer/barrel tolerances are set to achieve a low shear and polymer melt pressure settings. The masterbatch addition of microspheres of U.S. Pat. No. 4,556,603 can be utilized as well, but low shear conditions should still be retained.

The dynamic vulcanisation of the rubber phase, with subsequent addition of microspheres into the same extruder, but downstream of the vulcanisation reaction, is one method to practice the invention preparation process, as is provision of a previously prepared TPV composition into a melt mixer with addition of the microspheres to the mixer. Upon initial extrusion of the syntactic foams thus prepared, the microsphere-filled TPV can then be milled, chopped, pelletized, or processed by typical thermoplastic processing techniques. Subsequent compounding into strips, ribbons or extruded profiles can be accomplished through melt processing and extrusion means within the knowledge of those skilled in the art. Again, care is taken to avoid excessive shear or abrasion so as to avoid decrease of insulation properties. For example, injection molding pressure on the glass-bead reinforced polymer melt at or above 500 bar resulted in broken microspheres where glass beads were being used but where the extrusion pressure was maintained below 300 bar, the breakage was largely avoided. Care can be taken in application as well, for example, in a flexible pipe construction in a accordance with that of U.S. Pat. No. 6,701,969, the syntactic insulating layer comprising the microsphere-filled TPV can be included as an additional layer placed within the outer layers comprising the olefin polymer blend which acts as the abrasion resistant layers. The disclosures above (para. [0002]) with respect to marine applications, and flexible offshore piping are incorporated by reference for purposes of Unite States patent practice. For the purpose of this application “marine conduit” is intended to include flexible pipelines, electrical cables, tethering cables, and other linking connections used in the marine industry where insulation may be of benefit. In particular, marine conduits will benefit from the microsphere-filled TPV compositions of the invention where they have Shore hardness levels, as defined, from 80 Sh A to 60 Sh D, preferably from 90 Sh A to 40 Sh D.

### EXAMPLES

Sample compositions in accordance with the invention were prepared by introducing glass beads into molten thermoplastic vulcanizates under melt processing conditions. Specifically, a SANTOPRENE® TPV product, according to those listed in Table 1, was melt mixed within the recommended processing temperatures with subsequent addition of 3M™, Scotchlite™ Glass Bubbles, type S38XHS, hollow glass beads (average size: 50×10⁻⁶ m or 50 microns) in a twin screw extruder operated at low shear conditions for a period of time in which good dispersion of glass beads in the polymeric melt was achieved as assessed by visual inspection. The composite material was extruded and cut into strips for testing.

Table 1 shows measured properties of the examples illustrating the invention. Samples followed by (c) are comparative samples prepared without the addition of glass beads. The reported properties were measured in accordance with the following standards: density (ISO 1183); hardness (ISO 868-85); elongation at break and ultimate tensile strength (ISO 37 Type2); compression set (ISO 815 B); and, thermal conductivity (ISO 8301).

In Table 1, SANTOPRENE® 201-73 is a TPV product from Advanced Elastomer Systems having a Shore A hardness of 78. SANTOPRENE® 203-40 is a TPV product from Advanced Elastomer Systems having a Shore D hardness of 41. Each product is recommended for processing temperatures at temperatures of from 180 to 230° C. SANTOPRENE® 8291-80TB is a TPV product from Advanced Elastomer Systems having a Shore A hardness of 80 and a recommended processing temperature of 185 to 260° C. This last product contains additives that enhance bonding to polar surfaces and is tested here for its bonding ability to glass microspheres.

The examples illustrate the improved thermal insulation properties provided by the inclusion of the glass microspheres. Additionally, the examples illustrate that the mechanical properties sought in maintaining flexibility and elastic recovery properties remain acceptable for the targeted applications where elastomeric or rubbery properties are sought.

The invention claimed is that represented in the following affixed claims.

TABLE 1

| | Example # | | | | | | |
|---|---|---|---|---|---|---|---|
| | 1 (c) | 2 | 3 (c) | 4 | 5 (c) | 6 | 7 |
| TPE Product (SANTOPRENE ®) | 201-73 | 201-73 | 203-40 | 203-40 | 8291-80TB | 8291-80TB | 8291-80TB |
| Glass bead content (wt. %) | 0 | 15 | 0 | 25 | 0 | 25 | 30 |
| Hardness Sh A (ISO868-85) | 80 | 81 | 96 | 98 | 83 | 96 | 97 |
| Hardness Sh D (ISO868-85) | 19 | 20 | 42 | 41 | 20 | 31 | 32 |
| Density g/cm³ (ISO 1183) | | | | | | | |
| Strip (extr.) 3 mm thickness | 0.96 | 0.65 | 0.95 | 0.56 | | | |
| Plaque (inj) 3 mm thickness | 0.96 | 0.83 | 0.95 | 0.81 | 0.90 | 0.75 | 0.74 |
| Plaque (inj) 6 mm thickness | 0.92 | 0.76 | 0.93 | 0.71 | | | |
| Tensile (ISO37 Type2) | | | | | | | |
| Elongation at break (%) | 489 | 329 | 601 | 287 | 671 | 74 | 53 |
| Ultimate Tensile (MPa) | 8.9 | 3.1 | 21.3 | 5.3 | 11.3 | 5.1 | 5.1 |
| Compression Set¹ (ISO 815 B) | | | | | | | |
| RT (%) | 17 | 26 | 23 | 44 | 33 | 45 | 54 |
| 70° C. (%) | 34 | 44 | 48 | 68 | 51 | 58 | 65 |
| 100° C. (%) | 39 | 52 | 59 | 71 | 62 | 69 | 74 |
| Thermal Conductivity (ISO 8301) | | | | | | | |
| Lambda median (W/m · K) 20° C. | 0.179^{a} | 0.157^{a} | 0.182^{a} | 0.152^{a} | 0.174^{a} | 0.145^{b} | 0.146^{b} |
| Lambda median (W/m · K) 80° C. | — | — | — | — | 0.168^{a} | 0.148^{b} | 0.149^{b} |

¹Buttons dia. 13 mm, height 6 mm, cut ex injection molded plaques 100 × 100 × 6 mm
^{a}average Lambda measured on specimens of 3 and 6 mm
^{b}Lambda measured on 6 mm specimens only

1.-10. (canceled)

11. An insulating polymeric extrudate comprising:
a) a thermoplastic vulcanizate composition having a thermoplastic resin matrix phase having a dispersed phase of at least partially crosslinked rubber, and
b) hollow microspheres dispersed within the resin matrix phase.

12. The insulating polymeric extrudate of claim 11, wherein the thermoplastic resin constitutes from 15 to about 90 parts by weight.

13. The insulating polymeric extrudate of claim 11, wherein the insulating polymeric extrudate has a durometer from 80 Shore A to 60 Shore D.

14. The insulating polymeric extrudate of claim 11, wherein the thermoplastic resin is a polypropylene homo- or copolymer, or mix thereof, having a melting point (DSC) greater than 120° C.

15. The insulating polymeric extrudate of claim 14, wherein the thermoplastic resin constitutes from 15 to about 90 parts by weight.

16. The insulating polymeric extrudate of claim 14, wherein the insulating polymeric extrudate has a durometer from 80 Shore A to 60 Shore D.

17. The insulating polymeric extrudate of claim 11, wherein the cross-linked rubber comprises an ethylene-propylene-diene monomer copolymer rubber.

18. The insulating polymeric extrudate of claim 11, wherein said thermoplastic vulcanizate has been vulcanized such that not more than about 5 weight percent, based on the weight of the rubber, of the partially cross-linked rubber is extractable in boiling xylene.

19. The insulating polymeric extrudate of claim 11, wherein the hollow microspheres are prepared from glass.

20. The insulating polymeric extrudate of claim 19, wherein the thermoplastic resin phase further comprises a functionalized polyolefin thermoplastic and said microspheres have been treated for bonding to the functionalized polyolefin thermoplastic.

21. A marine conduit comprising:
an insulating layer comprising an insulating polymeric extrudate comprising:
a) a thermoplastic vulcanizate composition having a thermoplastic resin matrix phase having a dispersed phase of at least partially crosslinked rubber, and
b) hollow microspheres dispersed within the resin matrix phase.

22. The marine conduit of claim 21, wherein the thermoplastic resin constitutes from 15 to about 90 parts by weight.

23. The marine conduit of claim 21, wherein the insulating polymeric extrudate has a durometer from 80 Shore A to 60 Shore D.

24. The marine conduit of claim 21, wherein the thermoplastic resin is a polypropylene homo- or copolymer, or mix thereof, having a melting point (DSC) greater than 120° C.

25. The marine conduit of claim 24, wherein the thermoplastic resin constitutes from 15 to about 90 parts by weight.

26. The marine conduit of claim 24, wherein the insulating polymeric extrudate has a durometer from 80 Shore A to 60 Shore D.

27. The marine conduit of claim 21, wherein the cross-linked rubber comprises an ethylene-propylene-diene monomer copolymer rubber.

28. The marine conduit of claim 21, wherein said thermoplastic vulcanizate has been vulcanized such that not more than about S weight percent, based on the weight of the rubber, of the partially cross-linked rubber is extractable in boiling xylene.

29. The marine conduit of claim 21, wherein the hollow microspheres are prepared from glass.

30. The marine conduit of claim 29, wherein the thermoplastic resin phase further comprises a functionalized polyolefin thermoplastic and said microspheres have been treated for bonding to the functionalized polyolefin thermoplastic.
